(19) United States
(12) Patent Application Publication
(10) Pub. No.: US 2026/0239299 A1
(43) Pub. Date: Aug. 13, 2026

(54) RESOURCE SELECTION METHOD, COMMUNICATION NODE, AND STORAGE MEDIUM

(71) Applicant: ZTE CORPORATION, Shenzhen, Guangdong (CN)

(72) Inventors: Weimin XING, Shenzhen (CN); Youxiong LU, Shenzhen (CN); Feng BI, Shenzhen (CN); Jie CHEN, Shenzhen (CN)

(21) Appl. No.: 19/158,905

(22) PCT Filed: May 31, 2024
(86) PCT No.: PCT/CN2024/096561

§ 371 Date: Aug. 22, 2025

(30) Foreign Application Priority Data
Jul. 12, 2023 (CN) 202310859972.5

(51) Int. Cl. H04W 72/02; H04W 72/50

(52) U.S. Cl. CPC H04W 72/02; H04W 72/535

(57) ABSTRACT

Provided are a resource selection method, a communication node, and a storage medium. The resource selection method being applied by a first communication node includes: in a case where a to-be-checked resource is excluded from an available resource set, determining an exclusion condition of the to-be-checked resource; and in a case where the exclusion condition satisfies a first preset condition, transmitting resource check indication information, where the first preset condition includes a condition associated with a carrier corresponding to the to-be-checked resource among multiple carriers of the first communication node.

### CROSS-REFERENCE TO RELATED APPLICATIONS

This is a national stage application filed under 35 U.S.C. 371 based on International Patent Application No. PCT/CN2024/096561, filed on May 31, 2024, which claims priority to Chinese Patent Application No. 202310859972.5 filed with the China National Intellectual Property Administration (CNIPA) on Jul. 12, 2023, the disclosures of which are incorporated herein by reference in their entireties.

### TECHNICAL FIELD

The present application relates to the field of communications, for example, a resource selection method, a communication node, and a storage medium.

### BACKGROUND

New Radio (NR) direct communication only supports operations on one carrier. With the development of direct communication, transmission resources of a single carrier are limited, making it difficult to achieve high transmission rates and high reliability. In view of this, direct communication will support aggregating multiple carriers for communication.

However, no method supports resource selection on multiple carriers.

### SUMMARY

The present application provides a resource selection method, a communication node, and a storage medium.

In a first aspect, an embodiment of the present application provides a resource selection method. The method is applied by a first communication node and includes the following.

In a case where a to-be-checked resource is excluded from an available resource set, an exclusion condition of the to-be-checked resource is excluded; and in a case where the exclusion condition satisfies a first preset condition, resource check indication information is transmitted, where the first preset condition includes a condition associated with a carrier corresponding to the to-be-checked resource among multiple carriers of the first communication node.

In a second aspect, an embodiment of the present application provides a resource selection method. The method is applied by a second communication node and includes the following.

Resource check indication information is acquired; and a resource indicated by the resource check indication information is replaced from an available resource set, where the resource includes a to-be-checked resource satisfying a first preset condition and corresponding to a carrier among multiple carriers of a first communication node.

In a third aspect, an embodiment of the present application provides a communication node.

The communication node includes one or more processors and a storage apparatus configured to store one or more programs. The one or more programs, when executed by the one or more processors, are configured to cause the one or more processors to perform the resource selection method according to the first aspect and/or the second aspect of the present application.

In a fourth aspect, an embodiment of the present application provides a storage medium storing a computer program which, when executed by a processor, is configured to cause the processor to perform the resource selection method according to the first aspect and/or the second aspect of the present application.

### BRIEF DESCRIPTION OF DRAWINGS

FIG. 1 is a flowchart of a resource selection method according to an embodiment of the present application.

FIG. 2 is a flowchart of another resource selection method according to an embodiment of the present application.

FIG. 3 is a schematic diagram illustrating the structure of a resource selection apparatus according to an embodiment of the present application.

FIG. 4 is a schematic diagram illustrating the structure of another resource selection apparatus according to an embodiment of the present application.

FIG. 5 is a schematic diagram illustrating the structure of a communication node according to an embodiment of the present application.

### DETAILED DESCRIPTION

Embodiments of the present application are described hereinafter in conjunction with drawings. If not in collision, the embodiments of the present application and features in the embodiments may be combined with each other.

Operations illustrated in the flowcharts among the drawings may be performed by, for example, a computer system capable of executing a set of computer-executable instructions. Moreover, though logical sequences are illustrated in the flowcharts, in some cases, the operations illustrated or described may be performed in sequences different from the sequences described herein.

The terms “first”, “second” and the like in the present application are used for distinguishing between similar objects and are not necessarily used for describing a particular sequence or order.

Direct communication may also be referred to as sidelink (SL) communication, bypass communication or near field communication (NFC), such as vehicle-to-everything (V2X) communication and device-to-device (D2D) communication. Hereinafter, SL communication is used for referring to all kinds of direct communication. NR SL communication only supports operations on one carrier. With the development of direct communication, transmission resources of a single carrier are limited, making it difficult to achieve high transmission rates and high reliability. Therefore, supporting the aggregation of multiple carriers for SL communication will become a hot topic. However, the standard protocol does not support methods for resource selection on multiple carriers, such as a resource re-evaluation method for preventing a conflict between resources selected by user equipments (UEs) and a resource preemption method for preventing a conflict between resources reserved by UEs. Relevant solutions are required to address resource selection problems and prevent resource conflicts. A first communication node in the present application may be a UE.

To solve the preceding technical problems, the present application provides a resource selection method. In an embodiment, an SL resource selection process on a resource pool of a carrier is divided into two major processes described below.

In process 1: when data sending is required, before the sending, a higher layer may trigger the physical layer probing the usage of resources, commonly referred to as sensing. For example, the physical layer of the UE detects resources in a resource pool, excludes unavailable resources, and generates an available resource set. This set may also be referred to as a candidate resource set, denoted as Set A. The physical layer notifies the higher layer of Set A.

For process 1, one sub-operation is to detect and receive (that is, to sense) sidelink control information (SCI) sent by another UE and acquire parameters associated with the SCI. For example, through SCI of another UE, a resource (such as a reserved period and a reserved retransmission resource) reserved for the future of the other UE, a priority or a priority serial number of data of another UE, where generally, the smaller the priority serial number, the higher the priority, and energy detection reference signal received power (RSRP) corresponding to the SCI may be acquired. Through the parameters corresponding to the SCI, if a resource overlaps the resource reserved for the future of the SCI of another UE, and the detected energy corresponding to the SCI is greater than a threshold, the UE needs to exclude this resource. The initial value of the threshold is jointly determined by a sending priority of the UE and a priority corresponding to the detected SCI. Hereinafter, the preceding sub-operation of process 1 is described as a resource exclusion performed based on an overlap of a reserved resource of another UE, denoted as process 1-x.

In process 2, the higher layer selects one or more resources from the available resource set Set A for the preceding data sending.

Resource re-evaluation and resource preemption are mainly for checking the availability of the selected resource again to avoid conflicts. This check method is similar to the preceding resource selection process. Resource selection may also include resource re-evaluation and resource preemption. Hereinafter, unless otherwise specified, resource selection in the present application refers to at least one of resource selection, resource re-evaluation and resource preemption, and a resource check refers to at least one of resource re-evaluation and resource preemption. The resource check may also be simply described below.

In process 1a: when it is required to perform re-evaluation and/or preemption on one or more resources, the higher layer notifies the physical layer of to-be-re-evaluated resource Set R1 and/or to-be-preempted resource set Set R2. Before these resources are notified, the higher layer may trigger the physical layer sensing the resource pool, that is, trigger the preceding process 1. If it is found that some resources in Set R1 and/or Set R2 are no longer available, the physical layer notifies the higher layer of these no longer available resources, that is, reports resource check indication of these resources to the higher layer.

The execution order of process 1a is not limited, and process 1a may be executed after process 2. Set R1 and Set R2 may be sets selected by the higher layer from Set A.

In process 2a: If the higher layer receives a resource check indication of a resource, for example, the resource is reported as resource re-evaluation and/or resource preemption, the higher layer needs to select a new resource to replace the resource that is checked as an unavailable resource.

When the UE uses resources on multiple carriers for SL transmissions, from one carrier perspective, referred to as carrier A, the resource selection on this carrier may be affected by resource selection on another carrier, and may be limited by at least one of the factors described below.

Factor 1 refers to a limit to a carrier combination of multiple used carriers, that is, whether the finally used carrier is a carrier combination supported by the UE needs to be considered. For example, a typical UE may only support contiguous carrier aggregation, meaning that multiple carriers used must be contiguous on the frequency domain, or some carrier combinations on different frequency bands are not supported. In an instance, if the UE has already selected a resource on another carrier, and using resource x on carrier A would result in the UE ultimately using an unsupported carrier combination, such as using multiple non-contiguous carriers, the UE should exclude resource x from Set A, that is, resource x is excluded from Set A.

Factor 2 refers to a limit to the number of multiple carriers used simultaneously, that is, the number of carriers used simultaneously should not exceed a limit. For example, a typical UE can use a limited number of carriers simultaneously, and exceeding this limit may also cause conflicts between resources of multiple carriers. In an instance, if the UE has already selected a resource on another carrier and using resource x on carrier A would result in the UE ultimately using more carriers than the limit, for example, if the UE can use N carriers simultaneously, and using resource x on carrier A results in the final number of carriers used simultaneously exceeding N, the UE should exclude resource x, that is, resource x is excluded from Set A.

Factor 3 refers to a limit to an interruption time of radio frequency (RF) retuning between carriers, that is, the interruption caused by an RF retuning time (RTT) is taken into consideration. Generally, it takes time for a UE to switch from sending of one carrier to sending of another carrier, and resources within this retuning time generally cannot be used. For example, if the UE has already selected a resource for the transmission on slot n of another carrier, and it is assumed that the retuning time required by the UE retuning between the other carrier and carrier A is m slots, the UE cannot use m slots before slot n on carrier A and m slots after slot n on carrier A to avoid the interruption. In an instance, if the UE has already selected a resource on another carrier and using resource x on carrier A may cause interruption due to the radio frequency retuning time, the UE should exclude resource x from Set A, that is, resource x is excluded from Set A.

In an instance, the UE triggers sensing on the resource pool of carrier A. When the UE can use multiple resource pools on multiple carriers for transmissions, and it is assumed that the UE has already selected a resource for the transmission on another carrier, if using resource x on carrier A may result in the incapability of satisfying at least one of the preceding factors 1, 2, and 3, the UE needs to exclude resource x from the candidate resource set. That is, considering the resource already selected on another carrier and the limitation from at least one of factors 1, 2, and 3, the UE cannot use resource x on carrier A and needs to exclude resource x from Set A. Hereinafter, for the convenience of description, the preceding exclusion of resource x caused by factors of multiple carriers is referred to as process 1b.

In an example implementation, FIG. 1 is a flowchart of a resource selection method according to an embodiment of the present application. The method is applicable for cases of resource selection and may be executed by a resource selection apparatus provided in the present application. The resource selection apparatus may be implemented by software and/or hardware and integrated on the first communication node. The first communication node and the second communication node in the present application may be the same communication node or different communication nodes. In an example, the first communication node may be a first communication module, such as the physical layer module, and the second communication node may be a second communication module, such as a high-layer module above the physical layer module, like a media access control (MAC) module, etc. For example, the first communication node is the physical layer module of a UE, and the second communication node is the high-layer module of the UE. For another example, the first communication node is a UE, and the second communication node is a controller.

Exemplarily, the resource selection method disclosed in this embodiment may be included in process 1a. If it is determined that a resource is unavailable in process 1a, the method below of this embodiment is executed, and the application scenario of this embodiment is not limited here.

As shown in FIG. 1, the resource selection method provided in the present application includes S110 and S120.

In S110, in a case where a to-be-checked resource is excluded from an available resource set, an exclusion condition of the to-be-checked resource is determined.

The to-be-checked resource may be a resource that is to be checked, such as a resource to be subjected to an exclusion cause check. The available resource set may be a set formed by available resources. The exclusion condition may indicate a reason and/or process of excluding the to-be-checked resource from the available resource set.

In this embodiment, the first communication node may exclude an unavailable resource from the available resource set when detecting, that is, sensing, the available resource set. The excluded resource may be considered as the to-be-checked resource, and through S110, the exclusion condition of the to-be-checked resource can be determined.

How to determine that the to-be-checked resource is excluded from the available resource set is not limited here. For example, if a resource within the available resource set is determined as an unavailable resource, it may be considered that the to-be-checked resource is excluded from the available resource set.

S110 does not limit the means of determining the exclusion condition, but may determine, based on the sensing process and/or result of the available resource set, the reason why and/or the process that the to-be-checked resource is considered as an unavailable resource when the to-be-checked resource is detected.

In S120, in a case where the exclusion condition satisfies a first preset condition, resource check indication information is transmitted.

The first preset condition includes a condition associated with a carrier corresponding to the to-be-checked resource among multiple carriers of the first communication node, and the resource check indication information indicates selecting a resource for replacing the to-be-checked resource.

The first communication node in the present application supports direct communication on multiple carriers. The multiple carriers of the first communication node include the carrier corresponding to the to-be-checked resource. The first preset condition is the condition associated with the carrier corresponding to the to-be-checked resource. The first preset condition may be a condition associated with multiple carriers of the first communication node, or a condition associated with the carrier corresponding to the to-be-checked resource, such as a condition determined based on a transmission priority of a reserved resource of another communication node except the first communication node and a transmission priority when the direct communication transmission is performed on the carrier corresponding to the to-be-checked resource. The transmission priority when the direct communication transmission is performed on the carrier may be associated with a transmission priority of a resource corresponding to the carrier. For example, the UE selects a resource on each of four contiguous carriers CC1, CC2, CC3 and CC4 for SL transmission, and r1, r2, r3, and r4 are the resources selected on the four carriers respectively. A transmission priority corresponding to CC1 may be a transmission priority corresponding to r1.

In this embodiment, the first preset condition may be used for further determining whether to transmit the resource check indication information of the to-be-checked resource. In the case where the exclusion condition of the to-be-checked resource satisfies the first preset condition, the resource check indication information of the to-be-checked resource may be sent. The resource check indication information may indicate that the to-be-checked resource is an unavailable resource, and further indicates selecting a resource for replacing the to-be-checked resource. The resource check indication information may include an available resource set after the unavailable resource (such as the to-be-checked resource satisfying the first preset condition) is removed so that the higher layer can select a resource from the available resource set to replace the to-be-checked resource.

In an example, the resource selection method provided in this embodiment may be considered as a method for equipment to select a resource for a to-be-sent SL transmission on a resource pool of a carrier. For a resource that is under a resource check (that is, the to-be-checked resource), if the resource does not belong to the available resource set (that is, the to-be-checked resource is excluded from the available resource set), the reason/process of excluding the resource from the available resource set is determined (that is, the exclusion condition of the to-be-checked resource is determined). When the preset condition is satisfied (that is, the exclusion condition satisfies the first preset condition), the equipment (that is, the first communication node) reports a resource check indication (that is, the resource check indication information of the to-be-checked resource) of the resource to the higher layer (that is, the second communication node).

Various reasons exist for resource unavailability, and different reasons correspond to different conditions. In an embodiment, the preset condition (that is, the first preset condition) includes at least one of the conditions described below.

1) It is determined that the exclusion reason/process of the resource (that is, the to-be-checked resource) is an exclusion performed based on a limit to the multiple-carrier operation of the UE (that is, the exclusion condition satisfies the exclusion performed based on a carrier limit between the multiple carriers of the first communication node). For this reason/process, no additional preset conditions are needed, that is, the preset condition is to determine that the exclusion reason/process of the resource is a multiple-carrier operation exclusion of the UE, or the preset condition may also be described as that if it is determined that the resource satisfies the exclusion condition in the first process, the equipment reports the resource check indication of the resource to the higher layer.

In an instance, the resource is a resource excluded by the first process (that is, process 1b), in other words, the resource satisfies the exclusion condition in the first process (at least one of factors 1, 2 and 3 in process 1b). For example, if using this resource may result in the use of an unsupported carrier combination and thus lead to the exclusion of the resource, the physical layer sends a resource check indication to the higher layer, making the higher layer reselect a resource. In addition to the preceding check indication for the resource pool, the physical layer may also report the current available resource set to the higher layer. In an instance, the preceding available resource set does not include the resource excluded by the first process, that is, process 1b.

2) It is determined that the exclusion reason of the resource is a resource exclusion performed based on an overlap of a reserved resource determined by SCI of another UE (that is, an exclusion performed based on an overlap between a reserved resource of another communication node except the first communication node and the to-be-checked resource). For example, the resource is a resource excluded by the second process (that is, process 1-x), or the resource satisfies the exclusion condition in the second process. Further, another preset condition (that is, the second preset condition) further includes the following: a transmission priority of the resource associated with the SCI is higher than a priority of the SL transmission (that is, a transmission priority of the reserved resource of the other communication node is higher than a transmission priority of the to-be-checked resource), or a priority associated with the SCI is higher than the priority of the SL transmission and the priority associated with the SCI is higher than a configured resource check priority threshold.

3) It is determined that the exclusion reason of the resource is a resource exclusion performed based on an overlap of a reserved resource determined by SCI of another UE. For example, the resource is a resource excluded by the second process (that is, process 1-x), in other words, the resource satisfies the exclusion condition in the second process. Further, another preset condition further includes the following: if the UE has another to-be-sent SL transmission on another carrier (that is, the first communication node has a target resource with to-be-transmitted data on a carrier except the carrier corresponding to the to-be-checked resource), a priority associated with the SCI is higher than priorities of all to-be-sent SL transmissions (that is, a transmission priority of the reserved resource of another communication node is higher than a transmission priority of the target resource, and the transmission priority of the reserved resource of the other communication node is higher than a transmission priority of the to-be-checked resource); or the priority associated with the SCI (that is, the transmission priority of the reserved resource of the other communication node) is higher than the priorities of all to-be-sent SL transmissions and the priority associated with the SCI is higher than a configured resource check priority threshold.

According to the resource selection method provided in the present application, in the case where the to-be-checked resource is excluded from the available resource set, whether the exclusion condition of the to-be-checked resource satisfies the first preset condition is determined. In the case where the exclusion condition of the to-be-checked resource satisfies the first preset condition, the resource check indication information of the to-be-checked resource is sent to indicate that the to-be-checked resource is an unavailable resource. The first preset condition is the condition associated with the carrier corresponding to the to-be-checked resource among the multiple carriers of the first communication node. Through the preceding process, resource selection for the first communication node supporting multiple carriers is achieved, that is, resource selection in the scenario of direct communication performed on multiple carriers is achieved.

Based on the preceding embodiment, variant embodiments of the preceding embodiment are provided. It is to be noted here that for ease of description, only differences from the preceding embodiments are described in the variant embodiments.

In an embodiment, the first preset condition includes an exclusion performed based on a carrier limit between the multiple carriers of the first communication node.

In this embodiment, in the case where the exclusion condition satisfies the first preset condition, it may be considered that the exclusion reason/process of the to-be-excluded resource is determined as the exclusion performed based on the limit to the multiple-carrier operation of the UE (that is, the exclusion performed based on the carrier limit between multiple carriers).

The carrier limit between the multiple carriers may be considered as a limit between the multiple carriers in the scenario of multiple-carrier communication.

In an embodiment, the carrier limit between the multiple carriers includes one or more of the following: a limit to a carrier combination of multiple used carriers; a limit to the number of multiple carriers used simultaneously; and a limit to an interruption time of radio frequency retuning between carriers.

The limit to the carrier combination of multiple used carriers may be considered as a limit to the carrier combination composed of multiple carriers used by the first communication node.

The limit to the number of multiple carriers used simultaneously may be considered as a limit to the number of multiple carriers used simultaneously in the communication process of the first communication node.

The limit to the interruption time of radio frequency retuning between carriers may be considered as a limit to the RF retuning time in a case of retuning between carriers of the first communication node.

In an embodiment, the first preset condition includes an exclusion performed based on an overlap between a reserved resource of another communication node except the first communication node (that is, a reserved resource determined by SCI of another UE) and the to-be-checked resource.

The exclusion condition satisfying the first preset condition provided in this embodiment may be considered as that the exclusion reason of the to-be-checked resource is determined as a resource exclusion performed based on an overlap of a reserved resource determined by SCI of another UE.

In an embodiment, in the case where the exclusion condition satisfies the first preset condition, transmitting the resource check indication information includes that in a case where the exclusion condition satisfies the first preset condition and a carrier of the first communication node satisfies a second preset condition, the resource check indication information is transmitted, where the second preset condition is associated with the reserved resource of the other communication node and with transmission priorities of the multiple carriers of the first communication node.

In the case where the exclusion condition satisfies the first preset condition, the resource check indication information may be directly transmitted; alternatively, it may be further determined whether the carrier of the first communication node satisfies the second preset condition so that whether to transmit the resource check indication information of the to-be-checked resource is determined.

The second preset condition may define the hierarchy relationship between the transmission priority of the reserved resource of the other communication node and the transmission priorities of multiple carriers of the first communication node, which is not limited here.

In an embodiment, the second preset condition includes: the first communication node has a target resource with to-be-transmitted data on a carrier except the carrier corresponding to the to-be-checked resource; a transmission priority of the reserved resource of the other communication node is higher than a transmission priority of the target resource; and the transmission priority of the reserved resource of the other communication node is higher than a transmission priority of the to-be-checked resource.

The second preset condition of this embodiment may be considered as that the UE has another to-be-sent SL transmission on another carrier, and the priority associated with the SCI is higher than the priorities of all to-be-sent SL transmissions.

The carrier of the first communication node except the carrier corresponding to the to-be-checked resource may be considered as a carrier except the carrier corresponding to the to-be-checked resource among the multiple carriers corresponding to the first communication node, or as a carrier except the carrier corresponding to the to-be-checked resource in a carrier combination to which the carrier corresponding to the to-be-checked resource belongs.

The carrier of the first communication node except the carrier corresponding to the to-be-checked resource may be considered as another carrier of the first communication node, and a resource of to-be-transmitted data on the other carrier overlaps the to-be-checked resource in time.

The target resource may be understood as the resource with to-be-transmitted data on another carrier. In the embodiment, the target resource having the to-be-transmitted data may be understood as a to-be-sent SL transmission.

The reserved resource of another communication node may be considered as a resource reserved for another communication node. The transmission priority may be considered as a priority of a transmission, such as a priority of performing data transmission. The to-be-transmitted data may be considered as data that is to be transmitted, such as to-be-transmitted data of the first communication node.

In an embodiment, the second preset condition includes: the first communication node has a target resource with to-be-transmitted data on a carrier except the carrier corresponding to the to-be-checked resource; a transmission priority of the reserved resource of the other communication node is higher than a transmission priority of the target resource; the transmission priority of the reserved resource of the other communication node is higher than a transmission priority of the to-be-checked resource; and the transmission priority of the reserved resource of the other communication node is higher than a resource check priority threshold.

The second preset condition of this embodiment may be considered as that the UE has another to-be-sent SL transmission on another carrier, and the priority associated with the SCI is higher than the priorities of all to-be-sent SL transmissions and a configured resource check priority threshold. The resource check priority threshold may be understood as a priority threshold for performing a resource check, and the value of the resource check priority threshold is not limited. In the case where the priority associated with the SCI is higher than the resource check priority threshold, the resource check may be performed.

The carrier of the first communication node except the carrier corresponding to the to-be-checked resource may be considered as another carrier of the first communication node, and a resource of to-be-transmitted data of the other carrier overlaps the to-be-checked resource in time.

In an embodiment, one or more resource check priority thresholds are used, and the transmission priority of the reserved resource of the other communication node being higher than the resource check priority threshold includes the following.

The transmission priority of the reserved resource of the other communication node is higher than all resource check priority thresholds.

In an instance, for 2) or 3) of the first preset condition, if only the resource check is enabled, it is only required to determine whether the priority associated with the SCI is higher than the priority of the SL transmission corresponding to the to-be-checked resource or priorities of all to-be-sent SL transmissions (that is, the transmission priority of the reserved resource of the other communication node is higher than the transmission priority of the target resource; and the transmission priority of the reserved resource of the other communication node is higher than the transmission priority of the to-be-checked resource). However, if the resource check is not simply enabled, but a check priority threshold is configured, it is not only required to determine whether the priority associated with the SCI is higher than the priority of the SL transmission corresponding to the to-be-checked resource or the priorities of all to-be-sent SL transmissions, but also to determine whether the priority associated with the SCI is higher than the configured resource check priority threshold.

In an instance, being higher than the resource check threshold refers to being higher than all configured resource check thresholds (that is, the resource check priority threshold). The resource check priority threshold may be one threshold or multiple thresholds. For example, multiple thresholds may refer to that one carrier corresponds to one threshold or one resource pool corresponds to one threshold. Therefore, being higher than all configured resource check thresholds may be being higher than thresholds of all available carriers/resource pools, or being higher than thresholds configured for carriers/resource pools corresponding to all to-be-sent SL transmissions, for example, being higher than thresholds for all available carriers/resource pools of the first communication node, or being higher than thresholds configured for carriers/resource pools corresponding to all to-be-sent SL transmissions of the first communication node.

In an embodiment, the resource selection method further includes the following:

The available resource set from which the to-be-checked resource is excluded is transmitted.

In this embodiment, the available resource set may be reported to the higher layer, and the reported available resource set may be a set obtained after the to-be-checked resource satisfying the first preset condition is excluded. The higher layer may select a resource for replacement of the to-be-checked resource based on the transmitted available resource set to replace the to-be-checked resource that satisfies the first preset condition.

In an embodiment, in the case where the exclusion condition satisfies the first preset condition, transmitting the resource check indication information includes the following.

In a case where part or all of exclusion conditions of to-be-checked resources respectively corresponding to the multiple carriers of the first communication node satisfy the first preset condition, the resource check indication information is transmitted.

In the present application, the first communication node may correspond to multiple carriers, and each carrier may have a corresponding available resource set.

Multiple available resource sets of the first communication node may be detected. For each available resource set, it may be separately determined whether the to-be-checked resource satisfies the first preset condition. If the exclusion condition of a to-be-checked resource corresponding to one or more carriers among the multiple carriers of the first communication node satisfies the first preset condition, the resource check indication information may be transmitted. The resource check indication information may indicate the to-be-checked resource satisfying the first preset condition.

The number of to-be-checked resources satisfying the first preset condition is associated with the number of resource check indications, and the number of to-be-checked resources satisfying the first preset condition may be equal to the number of resource check indications.

In an embodiment, one piece of resource check indication information may be provided, and all to-be-checked resources that satisfy the first preset condition are indicated through this one piece of resource check indication information.

In this embodiment, transmissions of multiple carriers may be considered as a whole to determine whether to trigger the resource check indication. If resource indications of all to-be-checked resources need to be reported, the resource check indications for all resources are reported.

The multiple carriers of the first communication node may be all carriers of the first communication node, or may be all carriers in a carrier combination.

In an instance, 3) of the first preset condition further includes that the equipment (that is, the first communication node) reports a resource check indication of one or more of resources corresponding to a to-be-sent SL transmission of another carrier to the higher layer. That is, transmissions of multiple carriers may be considered as a whole to determine whether to trigger the resource check indication. If the condition is satisfied, not only can the resource check indication on the carrier where the to-be-checked resource is located be triggered, but the resource check indication on another carrier can also be triggered.

In an embodiment, resources respectively corresponding to the multiple carriers of the first communication node overlap in time.

The resources respectively corresponding to the multiple carriers of the first communication node overlapping in time may be considered as that the resource corresponding to the to-be-sent SL transmission of another carrier overlaps the to-be-checked resource.

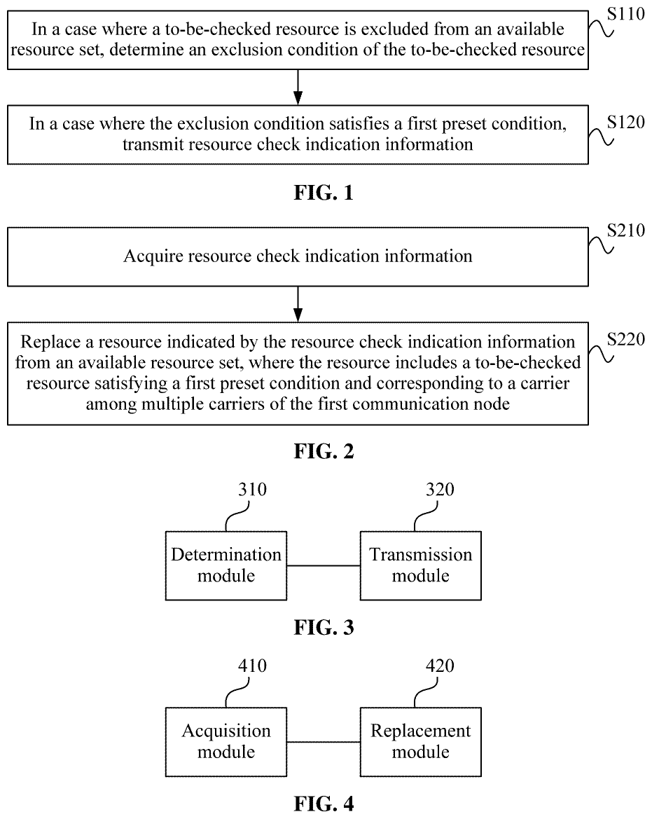

In an example implementation, an embodiment of the present application further provides a resource selection method. FIG. 2 is a flowchart of another resource selection method according to an embodiment of the present application. The resource selection method provided in this embodiment is applicable to the case of resource selection and may be executed by a resource selection apparatus provided in the present application. The resource selection apparatus may be implemented by software and/or hardware and integrated on a second communication node. For the content that is not yet exhaustive in this embodiment, reference may be made to the preceding embodiments. Details are not repeated herein.

As shown in FIG. 2, the resource selection method provided in the embodiment includes the following.

In S210, resource check indication information is acquired.

S210 may acquire the resource check indication information transmitted by a first communication node. The resource check indication information may be transmitted by the first communication node in a case where it is determined that an exclusion condition of a to-be-checked resource satisfies a first preset condition.

In S220, a resource indicated by the resource check indication information is replaced from an available resource set, where the resource includes a to-be-checked resource satisfying a first preset condition and corresponding to a carrier among multiple carriers of the first communication node.

After acquiring the resource check indication information, a second communication node may replace the resource indicated by the resource check indication information from the available resource set, such as selecting a resource from the available resource set and using the selected resource to replace the resource indicated by the resource check indication information. The resource indicated by the resource check indication information includes the to-be-checked resource satisfying the first preset condition and corresponding to a carrier among the multiple carriers of the first communication node. The resources indicated by the resource check indication information may also include to-be-checked resources satisfying the first preset condition and corresponding to multiple carriers among the multiple carriers of the first communication node, that is, the resource check indication information indicates the to-be-checked resources that satisfy the first preset condition as a whole.

In an example, if the higher layer receives a resource check indication of the resource, the higher layer reselects a resource from the available resource set to replace the resource indicated by the resource check indication information.

According to the resource selection method provided in this embodiment, after the resource check indication information is acquired, the resource indicated by the resource check indication information is replaced, so the resource selection for the first communication node supporting multiple carriers is achieved.

Based on the preceding embodiment, variant embodiments of the preceding embodiment are provided. It is to be noted here that for ease of description, only differences from the preceding embodiments are described in the variant embodiments.

In an embodiment, the resource selection method further includes the following.

A target resource of a target carrier of the first communication node is replaced, where the target carrier includes a carrier in a carrier combination to which the carrier corresponding to the resource check indication information belongs except the carrier corresponding to the resource check indication information.

In this embodiment, resources of all carriers in the carrier combination may be replaced. For example, resources in the carrier combination to which the carrier corresponding to the resource check indication information belongs are replaced.

The carrier corresponding to the resource check indication information may be considered as the carrier corresponding to the resource indicated by the resource check indication information.

The carrier combination to which the carrier belongs may be considered as a carrier combination that includes the carrier, and the first communication node uses the carrier combination for communication.

The target carrier may be a carrier except the carrier corresponding to the resource check indication information in the carrier combination to which the carrier corresponding to the resource check indication information belongs. The target resource may be considered as the resource corresponding to the target carrier.

For example, for a carrier combination {CC1, CC3, CC4}, the carrier corresponding to the resource check indication information is CC1, the target carrier is {CC3, CC4}, and the target resource is {r3, r4}; in this embodiment, r1, r3, and r4 may be replaced.

In an instance, after receiving the resource check indication of a resource, the higher layer may not only reselect a resource from the available resource set to replace the resource, but also select a new resource to replace a resource corresponding to a to-be-sent SL transmission of another carrier (that is, replace the target resource of the target carrier of the first communication node). That is, the higher layer considers transmissions of multiple carriers as a whole to determine whether to select a new resource for replacement.

In an instance, selecting a new resource to replace the resource corresponding to the to-be-sent SL transmission of the other carrier refers to selecting a resource from the available resource set corresponding to the other carrier to replace the resource corresponding to the to-be-sent SL transmission on the other carrier.

In an embodiment, the first preset condition includes an exclusion performed based on a carrier limit between the multiple carriers of the first communication node.

In an embodiment, the carrier limit between the multiple carriers includes one or more of the following: a limit to a carrier combination of multiple used carriers; a limit to the number of multiple carriers used simultaneously; and a limit to an interruption time of radio frequency retuning between carriers.

In an embodiment, the first preset condition includes an exclusion performed based on an overlap between the to-be-checked resource and a reserved resource of another communication node except the first communication node.

In an embodiment, the resource includes a to-be-check resource satisfying both the first preset condition and the second preset condition and corresponding to one carrier among the multiple carriers of the first communication node. The second preset condition is associated with the reserved resource of the other communication node and transmission priorities of the multiple carriers of the first communication node.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; and the transmission priority of the reserved resource of the other communication node is higher than a transmission priority of the to-be-checked resource.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; the transmission priority of the reserved resource of the other communication node is higher than a transmission priority of the to-be-checked resource; and the transmission priority of the reserved resource of the other communication node is higher than a resource check priority threshold.

In an embodiment, one or more resource check priority thresholds are provided, and the transmission priority of the reserved resource of the other communication node being higher than the resource check priority threshold includes the following.

The transmission priority of the reserved resource of the other communication node is higher than all resource check priority thresholds.

In an embodiment, the resource selection method further includes the following.

An available resource set from which the to-be-checked resource satisfying the first preset condition is excluded is acquired.

In an embodiment, the resource check indication information is transmitted in a case where part or all of exclusion conditions of to-be-checked resources respectively corresponding to the multiple carriers of the first communication node satisfy the first preset condition.

In an embodiment, the target resource and the resource indicated by the resource check indication information overlap in time.

The present application is exemplarily described below. The resource selection method provided in the present application may be considered as a bypass communication resource selection method. The present application solves the resource check problem of sidelink equipment during the multiple-carrier operation, ensuring the satisfaction of the limits to the multiple-carrier operation. In the present application, if the physical layer determines that a resource to be checked (that is, a to-be-checked resource) is a resource excluded due to the limit to the multiple-carrier operation (that is, a carrier limit between multiple carriers), the physical layer reports a resource check indication to the higher layer. Resources of multiple carriers are considered as a group of resources for checking, only when the priority of a detected conflict is higher than priorities of resources in this group (that is, the transmission priority of the reserved resource of the other communication node is higher than the transmission priority of the target resource; and the transmission priority of the reserved resource of the other communication node is higher than the transmission priority of the to-be-checked resource), a resource check is reported, that is, the resource check indication information may be transmitted.

### Instance 1

A typical sidelink grant includes one or more resources, and these resources are also referred to as resources selected by the grant. Resources that have not been used in these resources may include two types: resources that are indicated as reserved by the previous SCI, and resources that are not indicated as reserved by the previous SCI. For example, a grant includes eight resources, numbered r1, r2, . . . , and r8. It is assumed that a transmission may reserve the following two resources. If the UE sends an SL transmission on r1, and SCI of this SL transmission indicates later resources r2 and r3, r2 and r3 are the resources that are indicated as reserved by the previous SCI, while r4 to r8 are not indicated as reserved. Generally, preemption refers to performing a resource check on the resource indicated as reserved by the previous SCI, while re-evaluation refers to performing a resource check on the resource not indicated as reserved by the previous SCI.

When multiple carriers are used, a carrier may also be referred to as a component carrier (CC). The instance below is used for illustrating the resource check method for the resource exclusion performed based on the limit to the multiple-carrier operation of the UE.

The UE selects a resource on each of four contiguous carriers CC1, CC2, CC3 and CC4 for SL transmissions, and r1, r2, r3, and r4 correspond to the resources selected on the four carriers respectively. In this instance, it is assumed that the resource check process for each carrier is performed independently.

It is assumed that the UE triggers a resource check on resource r2 on CC2 and sends a resource check indication of r2. For example, the resource check for r2 is a preemption check, r2 is not in an available resource set, and the exclusion reason of r2 is a resource exclusion performed based on an overlap of a reserved resource determined by SCI of another UE (that is, an exclusion performed based on an overlap between a reserved resource of another communication node except the first communication node and the to-be-checked resource), that is, the preceding process 1-x or the second process. Moreover, the priority associated with the SCI of another UE in the check is higher than the priority of the SL transmission on r2 (that is, the transmission priority of the reserved resource of another communication node is higher than the transmission priority of the to-be-checked resource), or the priority associated with the SCI is higher than the priority of the SL transmission on r2 and the priority associated with the SCI is higher than a configured resource check priority threshold (that is, the transmission priority of the reserved resource of the other communication node is higher than the resource check priority threshold). At this time, the UE reports a preemption indication of r2 to the higher layer. For another example, the resource check for r2 is a re-evaluation check and r2 is not in an available resource set; at this time, the UE reports a re-evaluation indication of r2 to the higher layer. In an example, it can be seen that whether the type of the resource check is preemption or re-evaluation also has an impact on the reporting condition of the resource check. If the type of the resource check is preemption, the corresponding priority comparison needs to be performed, while for the re-evaluation, it is not necessary to determine the resource is excluded in which process, and the resource check indication may be triggered directly. The configuration generally refers to some configuration information provided by the network side entity to the UE, sometimes including pre-configuration, and is collectively referred to as configuration in the present application. The network side entity may be a base station or another network equipment.

The UE triggers a resource check on resource r1 on CC1, and after it is determined that r1 is not in the available resource set due to the limit of the multiple-carrier operation (that is, the exclusion performed based on the carrier limit between the multiple carriers of the first communication node), the UE needs to report the resource check of r1 to the higher layer. For example, since r2 is reselected, that is, r2 is no longer the selected resource, the UE turns to resource r3 selected on CC3 and r4 on CC4. If the UE continues using r1, it may result in an unsupported carrier combination of {CC1, CC3, CC4}. Therefore, the UE may exclude resource r1 from the available resource set, that is, use the resource exclusion by process 1-b or the first process. If the resource check of r1 is a preemption check, r1 is not in the available resource set and satisfies the resource exclusion condition of process 1-b or the first process, that is, r1 is a resource excluded by the limit of the multiple-carrier operation, the UE reports a preemption indication of r1 to the higher layer. For another example, if the resource check of r1 is a re-evaluation check and r1 is not in the available resource set, the UE reports a re-evaluation indication of r1 to the higher layer.

The UE triggers a resource check on resource r3 on CC3, and since r3 is in the available resource set, the UE does not need to report the resource check of r3 to the higher layer. For example, since the preceding r1 and r2 are reselected, that is, r1 and r2 are no longer the selected resources, the UE turns to r4 on CC4. If the UE continues using r3, and the carrier combination of {CC3, CC4} is an available and supported carrier combination, the UE may not exclude resource r3 from the available resource set due to the limit of the multiple-carrier operation, that is, using process 1-b or the first process may not exclude r3. If r3 is not excluded by other processes either, r3 remains in the available resource set and does not need to be reselected.

The UE triggers a resource check on resource r4 on CC4, and since r4 is in the available resource set, the UE does not need to report the resource check of r4 to the higher layer. For example, since the preceding r1 and r2 are reselected and r3 is retained, that is, r1 and r2 are no longer the selected resources, the UE may turn to r3 on CC3. If the UE continues using r4, and the carrier combination of {CC3, CC4} is an available and supported carrier combination, the UE may not exclude resource r4 from the available resource set due to the limit of the multiple-carrier operation, that is, using process 1-b or the first process may not exclude r4. If r4 is not excluded by other processes either, r4 remains in the available resource set and does not need to be reselected.

### Instance 2

Through the preceding instance 1, finally, r3 and r4 are retained, and r1 and r2 are reselected. If the order of resource checks is CC1, CC2, CC3 and CC4, resource r1 on CC1 is checked first. Since r2, r3, and r4 are still selected resources, r1 is not excluded due to the limit of the multiple-carrier operation, and resource r1 may be retained; for example, r1 is not excluded by other processes either. As mentioned above, if r2 is excluded by the second process, and a resource is reselected finally, r2 is no longer the selected resource; for r3 and r4, since r1 is retained and r2 is reselected, continuous use of r3 and r4 may result in an unsupported carrier combination, both r3 and r4 are excluded by the limit of the multiple-carrier operation, that is, both r3 and r4 require to be reselected, and only r1 is retained ultimately. It can be seen that the order of resource checks may affect the final result. The earlier a resource is checked, the easier the resource is to be retained. Generally, it may let the equipment determine the preceding order, or rules may be formulated to determine the order. In an instance, if resources on multiple carriers need resource checks, resources corresponding to transmissions with higher priorities may be checked first, that is, resource checks may be performed in descending order of priorities. Alternatively, resource checks may also be performed in ascending order of priorities.

In an instance, if resource checks are to be performed, the UE expects the higher layer to check the resources on multiple carriers instead of only checking some carriers. For example, as mentioned above, if the higher layer only triggers the resource check on r2, it may lead to that r1, r3, and r4 are used ultimately, causing an unsupported carrier combination. Therefore, if the resource checks are to be performed, the UE expects all of r1, r2, r3, and r4 to be checked. In other words, UE expects all carriers to have the same resource check configuration, such as all enabled or none enabled.

In an instance, if the ultimately selected resource does not satisfy the limit of the multiple-carrier operation, the UE prioritizes the sending of a transmission with a higher priority or abandons all transmissions. For example, if the higher layer only triggers the resource check of r2, it leads to the use of r1, r3 and r4 ultimately and causes an unsupported carrier combination, and the UE can only prioritize the sending of a transmission with a higher priority in the case of satisfying the limit. For example, if r1 has the highest priority, the transmission of r1 is sent, or the UE abandons all transmissions.

In another instance, if excluding/reselecting a resource results in not satisfying the limit of the multiple-carrier operation, the resource should not be excluded or reselected. For example, for resource r2 in instance 1, resource r2 should not be excluded or reselected. In other words, for a resource under the resource check, if the resource does not belong to the available resource set and reporting the resource check indication of the resource does not result in not satisfying the limit of the multiple-carrier operation, the equipment may report the resource check indication of the resource to the higher layer. On the contrary, if reporting the resource check indication of the resource results in not satisfying the limit to the multiple-carrier operation, the resource check indication is not reported.

### Instance 3

If it is determined that the exclusion reason of the resource is a resource exclusion performed based on an overlap of a reserved resource determined by SCI of another UE, a resource check leading to not satisfying the limit of the multiple-carrier operation needs to be avoided as much as possible. As described in instance 1, the UE selects the resource on each of four contiguous carriers CC1, CC2, CC3 and CC4 for SL transmissions, and r1, r2, r3, and r4 correspond to the resources selected on the four carriers respectively. It is assumed that the UE triggers a resource check on resource r2 on CC2, the resource check on r2 is a preemption check, and r2 is not in the available resource set, the exclusion reason of r2 is a resource exclusion performed based on an overlap of a reserved resource determined by SCI of another UE, that is, based on the preceding process 1-x or the second process.

For a case of a simple enabling resource check, if the priority associated with the SCI of the other UE is higher than the priority of any SL transmission on r1, r2, r3, or r4, or higher than the highest priority among the priorities of r1, r2, r3 and r4, the resource check indication of r2 is reported; otherwise, the resource check indication of r2 is not reported.

For a case of not a simple resource check, it is also required to check a priority threshold. If the priority associated with the SCI of the other UE is higher than the priority of any SL transmission on r1, r2, r3 or r4 and higher than a configured resource check priority threshold, the UE reports the preemption indication of r2 to the higher layer; otherwise, the UE does not report the preemption indication of r2.

It is assumed that the resource check indication of r2 is not reported finally, then r2, r3, and r4 may remain in the available resource sets of resource pools corresponding to their carriers respectively, without being reselected.

It can be seen that the probability of resource reselection on multiple carriers caused by the second process is greatly reduced.

### Instance 4

In an instance, to-be-checked resources of multiple carriers may be considered as a whole or as a group of resources for checking. For example, the UE selects a resource on each of four contiguous carriers CC1, CC2, CC3 and CC4 for SL transmissions, and r1, r2, r3 and r4 correspond to the resources selected on the four carriers respectively.

In an instance, if all to-be-checked resources need resource indication reporting, resource check indications of all resources are reported; otherwise, no resource check indication is reported (that is, in the case where all the exclusion conditions of to-be-checked resources respectively corresponding to the multiple carriers of the first communication node satisfy the first preset condition, the resource check indication information is transmitted). As described in the preceding instance, the determination of whether the resource of each carrier satisfies the condition of the resource check indication is performed individually. If the final result is that all resources satisfy the reporting condition, resource check indications of all resources are reported. If at least one resource does not satisfy the reporting condition, no resource check indication of any resource is reported. It can be seen that this manner reduces the probability of UE resource reselection, but increases the probability of conflicts with other UEs.

In another instance, if at least one of all to-be-checked resources needs resource indication reporting, resource check indications of all resources are reported (that is, in the case where part or all of the exclusion conditions of to-be-checked resources respectively corresponding to the multiple carriers of the first communication node satisfy the first preset condition, the resource check indication information is transmitted); otherwise, no resource check indication is reported. As described in the preceding instance, the determination of whether the resource of each carrier satisfies the condition of the resource check indication is performed individually. If the final result is that at least one resource satisfies the reporting condition, resource check indications of all the resources are reported. Only when all resources do not satisfy the reporting condition, none of the resource check indications of resources is reported. It can be seen that although this manner increases the probability of UE resource reselection, the probability of conflicts with other UEs is decreased.

### Instance 5

In an instance, the resource selection method further includes that when it is determined that the exclusion reason/process of the resource is a resource exclusion performed based on an undetected slot, the equipment abandons reporting the resource check indication of the resource to the higher layer; in other words, when it is determined that the exclusion reason/process of the resource is not a resource exclusion performed based on an undetected slot, the equipment reports the resource check indication of the resource to the higher layer. In an instance, the resource exclusion performed based on the undetected slot is also referred to as a third process. This process refers to that when the UE is in a sending state over a slot, the UE cannot detect that slot due to half-duplex limitations (that is, incapability of receiving during sending) and thus cannot acquire SCI sent by another UE in the current slot; to protect the transmission of the other UE, the UE assumes that various pieces of virtual SCI of different periods exist in this slot and performs a resource exclusion based on the virtual SCI. The sending state of the preceding UE in a slot may be that the UE is in the sending state on the current carrier or another carrier, or a module based on another radio access technology (RAT) in the equipment is in the sending state over the slot. For this resource exclusion caused by the virtual SCI, the UE does not actually discover resource conflicts, and should not abandon the selected resource, that is, should not report the resource check indication to the higher layer.

### Instance 6

In an instance, the resource selection method further includes when it is determined that the exclusion reason/process of the resource is a resource exclusion performed based on a resource detection report, the equipment reports the resource check indication of the resource to the higher layer. In an instance, the resource exclusion performed based on a resource conflict report is also referred to as a fourth process. The fourth process refers to that the UE excludes some resources based on a detection report provided by another UE or based on a detection report from an RAT module in the equipment. For the resource exclusion performed based on the resource detection report, although the UE does not discover resource conflicts by itself, a resource conflict discovered by another module or another UE is still real. Therefore, the UE should abandon the selected resource to avoid the conflict, that is, report the resource check indication to the higher layer.

Those skilled in the art should understand that the preceding various modules or operations of the present application may be implemented using general-purpose computing devices. The various modules or operations of the present application may be centralized on a single computing device or distributed on a network composed of multiple computing devices. Alternatively, the various modules or operations of the present application may be implemented using executable program codes of the computing device. In this manner, the various modules or operations of the present application can be stored in a storage device and executed by the computing device, or the various modules or operations of the present application can be separately made into various integrated circuit modules, or multiple modules or operations of the various modules or operations of the present application can be made into a single integrated circuit module for implementation. In this manner, the present application is not limited to any particular combination of hardware and software.

### Instance 7

In the resource selection method on a resource pool of a carrier, for a resource (which may be understood as the to-be-checked resource) reserved or selected by the UE, if the UE receives an unavailability indication of the resource or a resource conflict indication of the resource, for example, another UE may send a resource conflict indication to inform the UE that the resource is in conflict, the equipment (that is, the first communication node) reports a resource check indication (which may be understood as the resource check indication information of the to-be-checked resource) containing the resource to the higher layer (that is, the second communication node). The resource check indication here may also be understood as an indication for reporting a resource conflict to the higher layer.

Reporting the resource check indication containing the resource includes one of the following: reporting the to-be-checked resource to the higher layer; reporting the resource that overlaps the to-be-checked resource to the higher layer; or reporting the resource within a time segment (such as a slot) where the to-be-checked resource is located to the higher layer. In an instance, the specific resource to be reported to the higher layer may be determined by network-side configuration or pre-configuration.

Optionally, after the resource conflict indication of the resource is received, and before the resource check indication is reported, another preset condition needs to be satisfied, including one of the following.

The UE has another to-be-sent SL transmission on another carrier (that is, the first communication node has a target resource with to-be-transmitted data on a carrier except the carrier corresponding to the to-be-checked resource), and a transmission priority corresponding to the resource conflict indication is higher than priorities of all to-be-sent SL transmissions. Alternatively, the transmission priority corresponding to the resource conflict indication is higher than the priorities of all to-be-sent SL transmissions, and the transmission priority corresponding to the resource conflict indication is higher than a configured first resource conflict priority threshold.

Alternatively, the UE has another to-be-sent SL transmission on another carrier (that is, the first communication node has a target resource with to-be-transmitted data on a carrier except the carrier corresponding to the to-be-checked resource), and priorities of all to-be-sent SL transmissions are lower than a configured second resource conflict priority threshold.

After receiving the preceding resource check indication or the preceding resource conflict indication, the higher layer excludes the reported resource from the available resource set and selects a resource to replace the to-be-checked resource.

### Instance 8

The preceding carrier limit between the multiple carriers includes one or more of the following: a limit to a carrier combination of multiple used carriers; a limit to the number of the multiple carriers used simultaneously; and a limit to an interruption time of radio frequency retuning between carriers. If the resource selection is performed, the case where the selected resources of multiple carriers do not satisfy the carrier limit between the multiple carriers can be avoided to the greatest extent. However, if an exceptional case occurs, that is, if the resources of the multiple carriers do not satisfy the carrier limit between the multiple carriers, one solution is that the UE prioritizes the sending of the transmission with a higher transmission priority to satisfy the carrier limit. For example, resources are selected on CC1, CC2 and CC4 for transmissions; however, due to the unsupported carrier combination, the UE cannot perform the transmissions on these three carriers. If the transmission of CC1 has the highest priority, the UE may send the transmissions of CC1 and CC2 and abandon the transmission of CC4. If the transmission of the CC4 has the highest transmission priority, the UE prioritizes the sending of the transmission of CC4 and abandons the transmissions of CC1 and CC2.

### Instance 9

The preceding carrier limit between the multiple carriers includes one or more of the following: a limit to a carrier combination of multiple used carriers; a limit to the number of the multiple carriers used simultaneously; and a limit to an interruption time of radio frequency retuning between carriers. If the resource selection is performed, the case where the selected resources of multiple carriers do not satisfy the carrier limit between the multiple carriers can be avoided to the greatest extent. However, resources of some SL transmissions are not selected through the resource selection. For example, for a physical sidelink feedback channel (PSFCH), the resource of this feedback channel is directly determined through the location and other information of a data resource received by the feedback channel, and the UE cannot freely select a feedback resource when sending the feedback. For example, if UE1 receives data of UE2 on CC1, data of UE3 on CC2 and data of UE4 on CC4, and feedback channel locations determined by these data are at the same feedback time, the carrier combination when UE1 sends feedback is {CC1, CC2, CC4}, which is an unsupported carrier combination of UE1. It can be seen that although the resources selected by UE2, UE3, and UE4 for transmitting data all satisfy the multiple-carrier limit, it may still result in UE1 sending the feedback not satisfying the multiple-carrier limit.

One solution is as described in instance 8, that is, UE1 prioritizes the sending of the feedback channel with a higher priority while ensuring satisfying the multiple-carrier limit.

Another method is to introduce a universal signal to satisfy the multiple-carrier limit, such as sending a universal signal on CC3 on which no feedback channel is sent, so the carrier combination when UE1 sends the feedback becomes {CC1, CC2, CC3, CC4}.

Specifically, if the UE needs to send N feedback channels on a feedback occasion, these N feedback channels are located on M1 carriers (as in the preceding example, M1 is 3), and the frequency span of these N feedback channels includes M2 carriers (as in the preceding example, M2 is 4), the UE sends the universal signal on (M2−M1) carriers. The resource used by the universal signal is configured by the network side. For example, the network side may allocate a carrier a resource used by the universal signal corresponding to the carrier.

The above are merely preferred embodiments of the present application and are not intended to limit the present application. For those skilled in the art, the present application may have various modifications and variations. Any modifications, equivalent substitutions, improvements and the like made within the spirit and principle of the present application are within the scope of the present application.

In an example embodiment, the present application provides a resource selection apparatus. FIG. 3 is a schematic diagram illustrating the structure of a resource selection apparatus according to an embodiment of the present application. As shown in FIG. 3, the resource selection apparatus the embodiments of the present application may be integrated on the first communication node. The apparatus includes a determination module 310 and a transmission module 320.

The determination module 310 is configured to, in a case where a to-be-checked resource is excluded from an available resource set, determine an exclusion condition of the to-be-checked resource. The transmission module 320 is configured to, in a case where the exclusion condition satisfies a first preset condition, transmit resource check indication information, where the first preset condition includes a condition associated with a carrier corresponding to the to-be-checked resource among multiple carriers of the first communication node.

The resource selection apparatus provided in this embodiment is configured to perform the resource selection method of the embodiment shown in FIG. 1. The resource selection apparatus provided in this embodiment has similar implementation principles and technical effects to the resource selection method of the embodiment shown in FIG. 1, which are not repeated herein.

Based on the preceding embodiments, variant embodiments of the preceding embodiment are provided. It is to be noted here that for ease of description, only differences from the preceding embodiment are described in the variant embodiments.

In an embodiment, the first preset condition includes an exclusion performed based on a carrier limit between the multiple carriers of the first communication node.

In an embodiment, the carrier limit between the multiple carriers includes one or more of the following: a limit to a carrier combination of multiple used carriers; a limit to the number of multiple carriers used simultaneously; and a limit to an interruption time of radio frequency retuning between carriers.

In an embodiment, the first preset condition includes an exclusion performed based on an overlap between a reserved resource of another communication node except the first communication node and the to-be-checked resource.

In an embodiment, the transmission module 320 is specifically configured to, in a case where the exclusion condition satisfies the first preset condition and a carrier among the multiple carriers of the first communication node satisfies a second preset condition, transmit the resource check indication information, where the second preset condition is associated with the reserved resource of the other communication node and transmission priorities of the multiple carriers of the first communication node.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; and the transmission priority of the reserved resource of the other communication node is higher than a transmission priority of the to-be-checked resource.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; the transmission priority of the reserved resource of the other communication node is higher than a transmission priority of the to-be-checked resource; and the transmission priority of the reserved resource of the other communication node is higher than a resource check priority threshold.

In an embodiment, one or more resource check priority thresholds are provided, and the transmission priority of the reserved resource of the other communication node being higher than the resource check priority threshold includes that the transmission priority of the reserved resource of the other communication node is higher than all the resource check priority thresholds.

In an embodiment, this apparatus further includes a set transmission module.

The set transmission module is configured to transmit the available resource set from which the to-be-checked resource is excluded.

In an embodiment, the transmission module 320 is specifically configured to transmit the resource check indication information in a case where part or all of exclusion conditions of to-be-checked resources respectively corresponding to the multiple carriers of the first communication node satisfy the first preset condition.

In an embodiment, resources respectively corresponding to the multiple carriers of the first communication node overlap in time.

In an example implementation, the present application provides a resource selection apparatus. FIG. 4 is a schematic diagram illustrating the structure of another resource selection apparatus according to an embodiment of the present application. The resource selection apparatus provided in the embodiment may be integrated on a second communication node, and the apparatus includes an acquisition module 410 and a replacement module 420.

The acquisition module 410 is configured to acquire resource check indication information. The replacement module 420 is configured to replace a resource indicated by the resource check indication information from an available resource set, where the resource includes a to-be-checked resource satisfying a first preset condition and corresponding to a carrier among multiple carriers of a first communication node.

The resource selection apparatus provided in this embodiment is configured to perform the resource selection method of the embodiment shown in FIG. 2. The resource selection apparatus provided in this embodiment has similar implementation principles and technical effects to the resource selection method of the embodiment shown in FIG. 2, which are not repeated herein.

Based on the preceding embodiments, variant embodiments of the preceding embodiment are provided. It is to be noted here that for ease of description, only differences from the preceding embodiments are described in the variant embodiments.

In an embodiment, the resource selection apparatus further includes a resource replacement module. The resource replacement module is configured to replace a target resource of a target carrier of the first communication node, where the target carrier includes a carrier in a carrier combination to which the carrier corresponding to the resource check indication information belongs except the carrier corresponding to the resource check indication information.

In an embodiment, the first preset condition includes an exclusion based on a carrier limit between the multiple carriers of the first communication node.

In an embodiment, the carrier limit between the multiple carriers includes one or more of the following: a limit to a carrier combination of multiple used carriers; a limit to the number of multiple carriers used simultaneously; and a limit to an interruption time of radio frequency retuning between carriers.

In an embodiment, the first preset condition includes an exclusion performed based on an overlap between a reserved resource of another communication node except the first communication node and the to-be-checked resource.

In an embodiment, the resource includes the to-be-check resource satisfying both the first preset condition and a second preset condition and corresponding to one carrier among the multiple carriers of the first communication node. The second preset condition is associated with the reserved resource of the other communication node and transmission priorities of the multiple carriers of the first communication node.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; and the transmission priority of the reserved resource of the other communication node is higher than a transmission priority of the to-be-checked resource.

In an embodiment, the second preset condition includes the following: the first communication node has a target resource with to-be-transmitted data on a carrier except the carrier corresponding to the to-be-checked resource; a transmission priority of the reserved resource of the other communication node is higher than a transmission priority of the target resource; the transmission priority of the reserved resource of the other communication node is higher than a transmission priority of the to-be-checked resource; and the transmission priority of the reserved resource of the other communication node is higher than a resource check priority threshold.

In an embodiment, one or more resource check priority thresholds are provided, and the transmission priority of the reserved resource of the other communication node being higher than the resource check priority threshold includes that the transmission priority of the reserved resource of the other communication node is higher than all the resource check priority thresholds.

In an embodiment, the resource selection apparatus further includes a set acquisition module.

The set acquisition module is configured to acquire the available resource set from which the to-be-checked resource satisfying the first preset condition is excluded.

In an embodiment, the resource check indication information is transmitted in a case where part or all of exclusion conditions of to-be-checked resources respectively corresponding to the multiple carriers of the first communication node satisfy the first preset condition.

In an embodiment, the target resource and the resource indicated by the resource check indication information overlap in time.

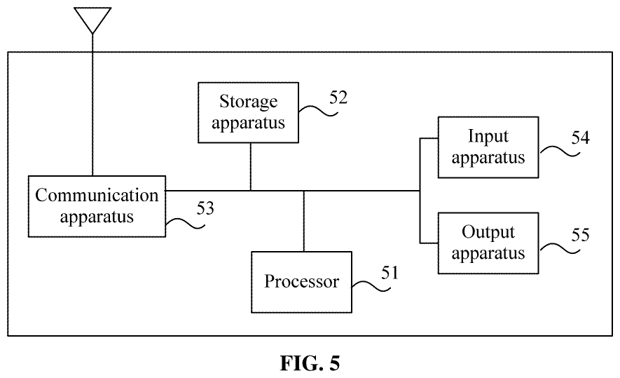

In an example implementation, the present application further provides a communication node. FIG. 5 is a schematic diagram illustrating the structure of a communication node according to an embodiment of the present application. As shown in FIG. 5, the communication node provided in the present application includes one or more processors 51 and a storage apparatus 52. One or more processors 51 may be provided in the communication node. In FIG. 5, one processor 51 is used as an example. The storage apparatus 52 is configured to store one or more programs. When executed by the one or more processors 51, the one or more programs cause the one or more processors 51 to perform the resource selection method according to the embodiment of the present application.

The communication node in this embodiment may be the first communication node or the second communication node.

In a case where the communication node executes the resource selection method shown in FIG. 1, the communication node may be the first communication node. In a case where the communication node executes the resource selection method shown in FIG. 2, the communication node may be the second communication node.

The communication node further includes a communication apparatus 53, an input apparatus 54 and an output apparatus 55.

The processor 51, the storage apparatus 52, the communication apparatus 53, the input apparatus 54 and the output apparatus 65 in the communication node may be connected via a bus or in other manners. FIG. 5 uses connection via a bus as an example.

The input apparatus 54 may be configured to receive inputted digital or character information and generate key signal input related to user settings and function control of the communication node. The output apparatus 55 may include a display screen and other display devices.

The communication apparatus 53 may include a receiver and a sender. The communication apparatus 53 is configured to perform information transceiving communications under the control of the processor 51. The information may be the resource check indication information.

As a computer-readable storage medium, the storage apparatus 52 may be configured to store software programs, computer-executable programs and modules, such as program instructions/modules (for example, the determination module 310 and the transmission module 320 in the resource selection apparatus; for another example, the acquisition module 410 and the replacement module 420 in the resource selection apparatus) corresponding to the resource selection method according to the embodiment of the present application. The storage apparatus 52 may include a program storage region and a data storage region, where the program storage region may store an operating system and an application program required by at least one function while the data storage region may store data created depending on use of the communication node. In addition, the storage apparatus 52 may include a high-speed random-access memory and may further include a nonvolatile memory such as at least one disk memory, a flash memory or another nonvolatile solid-state memory. In some examples, the storage apparatus 52 may further include memories which are remotely disposed with respect to the processor 51. These remote memories may be connected to the communication node via a network. Examples of the network include, but are not limited to, the Internet, an intranet, a local area network, a mobile communication network and a combination thereof.

In an example implementation, an embodiment of the present application further provides a storage medium storing a computer program which, when executed by a processor, causes the processor to perform any method according to the present application. The storage medium stores a computer program which, when executed by a processor, causes the processor to perform any resource selection method according to the embodiments of the present application, such as the resource selection method applied by the first communication node or the resource selection method applied by the second communication node. The resource selection method being applied by the first communication node includes the following: in a case where a to-be-checked resource is excluded from an available resource set, an exclusion condition of the to-be-checked resource is determined; and in a case where the exclusion condition satisfies a first preset condition, resource check indication information is transmitted, where the first preset condition includes a condition associated with a carrier corresponding to the to-be-checked resource among multiple carriers of the first communication node.

The resource selection method being applied by the second communication node includes the following: resource check indication information is acquired; and a resource indicated by the resource check indication information is replaced from an available resource set, where the resource includes a to-be-checked resource satisfying a first preset condition and corresponding to a carrier among multiple carriers of a first communication node.

A computer storage medium of an embodiment of the present application may be one computer-readable medium or any combination of multiple computer-readable media. The computer-readable medium may be a computer-readable signal medium or a computer-readable storage medium. For example, the computer-readable storage medium may be, but is not limited to, an electrical, magnetic, optical, electromagnetic, infrared or semiconductor system, apparatus, or device, or any combination thereof. Examples of the computer-readable storage medium (a non-exhaustive list) include an electrical connection having one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical memory, a magnetic memory or any suitable combination thereof. The computer-readable storage medium may be any tangible medium including or storing a program. The program may be used by or used in conjunction with an instruction execution system, apparatus or device.

The computer-readable signal medium may include a data signal propagated in a baseband or as part of a carrier. The data signal carries computer-readable program codes. The data signal propagated in this manner may be in multiple forms, including, but not limited to, an electromagnetic signal, an optical signal or any suitable combination thereof. The computer-readable signal medium may also be any computer-readable medium other than the computer-readable storage medium. The computer-readable medium may send, propagate or transmit a program used by or used in conjunction with an instruction execution system, apparatus or device.

Program codes included in the computer-readable media may be transmitted by any suitable medium including, but not limited to, a wireless medium, a wire, an optical cable, a radio frequency (RF) or any suitable combination thereof.

Computer program codes for performing the operations of the present application may be written in one or more programming languages or a combination thereof. The one or more programming languages include object-oriented programming languages such as Java, Smalltalk, C++, as well as conventional procedural programming languages such as “C” or similar programming languages. The program codes may be executed entirely on a user computer, executed partly on a user computer, executed as a stand-alone software package, executed partly on a user computer and partly on a remote computer, or executed entirely on a remote computer or a server. In the case where the remote computer is involved, the remote computer may be connected to the user computer through any type of network including a local area network (LAN) or a wide area network (WAN), or may be connected to an external computer (for example, via the Internet provided by an Internet service provider).

The preceding are example embodiments of the present application and are not intended to limit the scope of the present application.

It is to be understood by those skilled in the art that the term terminal device encompasses any appropriate type of radio user device such as a mobile phone, a portable data processing apparatus, a portable web browser or a vehicle-mounted mobile station.

Generally speaking, embodiments of the present application may be implemented in hardware or special-purpose circuits, software, logic or any combination thereof. For example, some aspects may be implemented in hardware while other aspects may be implemented in firmware or software executable by a controller, a microprocessor or another computing apparatus, though the present application is not limited thereto.

Embodiments of the present application may be implemented through the execution of computer program instructions by a data processor of a mobile apparatus, for example, implemented in a processor entity, by hardware or by a combination of software and hardware. The computer program instructions may be assembly instructions, instruction set architecture (ISA) instructions, machine instructions, machine-related instructions, microcodes, firmware instructions, status setting data or source or object codes written in any combination of one or more programming languages.

A block diagram of any logic flow among the drawings of the present application may represent program operations, may represent interconnected logic circuits, modules and functions, or may represent a combination of program operations and logic circuits, modules and functions. Computer programs may be stored in a memory. The memory may be of any type suitable for a local technical environment and may be implemented using any suitable data storage technology such as, but not limited to, a read-only memory (ROM), a random-access memory (RAM) or an optical memory device and system (a digital video disc (DVD) or a compact disc (CD)). Computer-readable media may include non-transitory storage media. The data processor may be of any type suitable for the local technical environment, such as, but not limited to, a general-purpose computer, a special-purpose computer, a microprocessor, a digital signal processor(DSP), an application-specific integrated circuit (ASIC), a field-programmable gate array (FPGA) and a processor based on a multi-core processor architecture.

1. A resource selection method, being applied by a first communication node and comprising:
in response to a to-be-checked resource being excluded from an available resource set, determining an exclusion condition of the to-be-checked resource; and
in response to the exclusion condition satisfying a first preset condition, transmitting resource check indication information, wherein the first preset condition comprises a condition associated with a carrier corresponding to the to-be-checked resource among a plurality of carriers of the first communication node.

2. The resource selection method according to claim 1, wherein the first preset condition comprises:
an exclusion performed based on a carrier limit between the plurality of carriers of the first communication node.

3. The resource selection method according to claim 2, wherein the carrier limit between the plurality of carriers comprises at least one of:
a limit to a carrier combination of a plurality of used carriers;
a limit to a number of a plurality of carriers used simultaneously; or
a limit to an interruption time of radio frequency retuning between carriers.

4. The resource selection method according to claim 1, wherein the first preset condition comprises:
an exclusion performed based on an overlap between the to-be-checked resource and a reserved resource of another communication node except the first communication node.

5. The resource selection method according to claim 4, wherein in response to the exclusion condition satisfying the first preset condition, transmitting the resource check indication information comprises:
in response to the exclusion condition satisfying the first preset condition and a carrier among the plurality of carriers of the first communication node satisfying a second preset condition, transmitting the resource check indication information, wherein the second preset condition is associated with both the reserved resource of the another communication node and transmission priorities of the plurality of carriers of the first communication node.

6. The resource selection method according to claim 5, wherein the second preset condition comprises the following:
the first communication node has a target resource with to-be-transmitted data on a carrier of the plurality of carriers except the carrier corresponding to the to-be-checked resource;
a transmission priority of the reserved resource of the another communication node is higher than a transmission priority of the target resource; and
the transmission priority of the reserved resource of the another communication node is higher than a transmission priority of the to-be-checked resource.

7. The resource selection method according to claim 5, wherein the second preset condition comprises:
the first communication node has a target resource with to-be-transmitted data on a carrier of the plurality of carriers except the carrier corresponding to the to-be-checked resource;
a transmission priority of the reserved resource of the another communication node is higher than a transmission priority of the target resource;
the transmission priority of the reserved resource of the another communication node is higher than a transmission priority of the to-be-checked resource; and
the transmission priority of the reserved resource of the another communication node is higher than a resource check priority threshold.

8. The resource selection method according to claim 7, wherein at least one resource check priority threshold is provided, and the transmission priority of the reserved resource of the another communication node being higher than the resource check priority threshold comprises:
the transmission priority of the reserved resource of the another communication node is higher than all the at least one resource check priority threshold.

9. The resource selection method according to claim 1, further comprising:
transmitting the available resource set from which the to-be-checked resource is excluded.

10. The resource selection method according to claim 1, wherein in response to the exclusion condition satisfying the first preset condition, transmitting the resource check indication information comprises:
in response to part or all of exclusion conditions of to-be-checked resources respectively corresponding to the plurality of carriers of the first communication node satisfying the first preset condition, transmitting the resource check indication information.

11. The resource selection method according to claim 10, wherein resources respectively corresponding to the plurality of carriers of the first communication node overlap in time.

12. A resource selection method, being applied by a second communication node and comprising:
acquiring resource check indication information; and
replacing a resource indicated by the resource check indication information from an available resource set, wherein the resource comprises a to-be-checked resource satisfying a first preset condition and corresponding to a carrier among a plurality of carriers of a first communication node.

13. The resource selection method according to claim 12, further comprising:
replacing a target resource of a target carrier of the first communication node, wherein
the target carrier comprises a carrier in a carrier combination to which the carrier corresponding to the resource check indication information belongs except the carrier corresponding to the resource check indication information.

14. A communication node, comprising:
at least one processor; and
a storage apparatus configured to store at least one program,
wherein the at least one program, when executed by the at least one processor, is configured to cause the at least one processor to perform the following:
in response to a to-be-checked resource being excluded from an available resource set, determining an exclusion condition of the to-be-checked resource; and
in response to the exclusion condition satisfying a first preset condition, transmitting resource check indication information, wherein the first preset condition comprises a condition associated with a carrier corresponding to the to-be-checked resource among a plurality of carriers of the communication node.

15. A non-transitory storage medium storing a computer program which, when executed by a processor, is configured to cause the processor to perform the resource selection method according to claim 1.

16. The communication node according to claim 14, wherein the first preset condition comprises:
an exclusion performed based on a carrier limit between the plurality of carriers of the communication node.

17. The communication node according to claim 16, wherein the carrier limit between the plurality of carriers comprises at least one of:
a limit to a carrier combination of a plurality of used carriers;
a limit to a number of a plurality of carriers used simultaneously; or
a limit to an interruption time of radio frequency retuning between carriers.

18. The communication node according to claim 14, wherein the first preset condition comprises:
an exclusion performed based on an overlap between the to-be-checked resource and a reserved resource of another communication node except the communication node.

19. The communication node according to claim 18, wherein in response to the exclusion condition satisfying the first preset condition, transmitting the resource check indication information comprises:
in response to the exclusion condition satisfying the first preset condition and a carrier among the plurality of carriers of the communication node satisfying a second preset condition, transmitting the resource check indication information, wherein the second preset condition is associated with both the reserved resource of the another communication node and transmission priorities of the plurality of carriers of the communication node.

20. The communication node according to claim 19, wherein the second preset condition comprises the following:
the communication node has a target resource with to-be-transmitted data on a carrier of the plurality of carriers except the carrier corresponding to the to-be-checked resource;
a transmission priority of the reserved resource of the another communication node is higher than a transmission priority of the target resource; and
the transmission priority of the reserved resource of the another communication node is higher than a transmission priority of the to-be-checked resource.
